(19) United States
(12) Patent Application Publication
(10) Pub. No.: US 2026/0095267 A1
(43) Pub. Date: Apr. 2, 2026

(54) INTERFERENCE PREDICTION EVENTS

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 18/903,325

(22) Filed: Oct. 1, 2024

(51) Int. Cl. H04B 17/336; H04B 17/391

(52) U.S. Cl. CPC H04B 17/336; H04B 17/3913

(57) ABSTRACT

Various aspects of the present disclosure generally relate to wireless communication. In some aspects, a user equipment (UE) may detect that an interference prediction event that indicates to generate an interference prediction for a future air interface resource has occurred. The UE may transmit, based at least in part on detecting that the interference prediction event has occurred, an event-triggered interference prediction report that includes the interference prediction. Numerous other aspects are described.

### FIELD OF THE DISCLOSURE

Aspects of the present disclosure generally relate to wireless communication and specifically relate to techniques, apparatuses, and methods associated with interference prediction events.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include detecting that an interference prediction event that indicates to generate an interference prediction for a future air interface resource has occurred. The method may include transmitting, based at least in part on detecting that the interference prediction event has occurred, an event-triggered interference prediction report that includes the interference prediction.

Some aspects described herein relate to a method of wireless communication performed by a network node. The method may include receiving an event-triggered interference prediction report that includes an interference prediction generated by a UE, the event-triggered interference prediction report being associated with an interference prediction event. The method may include transmitting an air interface resource allocation that is assigned to the UE, the air interface resource allocation being configured to mitigate interference that is indicated by the interference prediction.

Some aspects described herein relate to an apparatus for wireless communication at a UE. The apparatus may include one or more memories and one or more processors coupled to the one or more memories. The one or more processors may be configured to detect that an interference prediction event that indicates to generate an interference prediction for a future air interface resource has occurred. The one or more processors may be configured to transmit, based at least in part on detecting that the interference prediction event has occurred, an event-triggered interference prediction report that includes the interference prediction.

Some aspects described herein relate to an apparatus for wireless communication at a network node. The apparatus may include one or more memories and one or more processors coupled to the one or more memories. The one or more processors may be configured to receive an event-triggered interference prediction report that includes an interference prediction generated by a UE, the event-triggered interference prediction report being associated with an interference prediction event. The one or more processors may be configured to transmit an air interface resource allocation that is assigned to the UE, the air interface resource allocation being configured to mitigate interference that is indicated by the interference prediction.

Some aspects described herein relate to a non-transitory computer-readable medium that stores a set of instructions for wireless communication by a UE. The set of instructions, when executed by one or more processors of the UE, may cause the UE to detect that an interference prediction event that indicates to generate an interference prediction for a future air interface resource has occurred. The set of instructions, when executed by one or more processors of the UE, may cause the UE to transmit, based at least in part on detecting that the interference prediction event has occurred, an event-triggered interference prediction report that includes the interference prediction.

Some aspects described herein relate to a non-transitory computer-readable medium that stores a set of instructions for wireless communication by a network node. The set of instructions, when executed by one or more processors of the network node, may cause the network node to receive an event-triggered interference prediction report that includes an interference prediction generated by a UE, the event-triggered interference prediction report being associated with an interference prediction event. The set of instructions, when executed by one or more processors of the network node, may cause the network node to transmit an air interface resource allocation that is assigned to the UE, the air interface resource allocation being configured to mitigate interference that is indicated by the interference prediction.

Some aspects described herein relate to an apparatus for wireless communication. The apparatus may include means for detecting that an interference prediction event that indicates to generate an interference prediction for a future air interface resource has occurred. The apparatus may include means for transmitting, based at least in part on detecting that the interference prediction event has occurred, an event-triggered interference prediction report that includes the interference prediction.

Some aspects described herein relate to an apparatus for wireless communication. The apparatus may include means for receiving an event-triggered interference prediction report that includes an interference prediction generated by a UE, the event-triggered interference prediction report being associated with an interference prediction event. The apparatus may include means for transmitting an air interface resource allocation that is assigned to the UE, the air interface resource allocation being configured to mitigate interference that is indicated by the interference prediction.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example of interference, in accordance with the present disclosure.

FIG. 4 is a diagram illustrating an example of a wireless communication process between a network node and a UE, in accordance with the present disclosure.

FIG. 5 is a diagram illustrating an example process performed, for example, at a UE or an apparatus of a UE, in accordance with the present disclosure.

FIG. 6 is a diagram illustrating an example process performed, for example, at a network node or an apparatus of a network node, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

FIG. 9 is a diagram illustrating an example architecture of a functional framework for radio access network intelligence enabled by data collection, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Interference in a wireless communication system is a disruption to a signal that may degrade a quality of the signal and/or communications conveyed by the signal, such as a disruption that reduces a signal-to-noise ratio (SNR) and/or increases recovery errors at a receiver. To mitigate interference, a user equipment (UE) may generate one or more measurement metrics to estimate a channel quality and/or interference in a signal received by the UE, and the measurement metrics may be used to modify transmission parameters in a manner that mitigates the interference. For instance, the UE may transmit a report that indicates the channel estimation measurement metrics and/or the interference measurement metrics to a network node, and the network node may modify one or more transmission parameters to mitigate the interference.

The selection, scheduling, and use of the modified transmission parameters may be delayed from when the UE observes and generates the measurement metrics, and the delay may be large enough to cause a mismatch between the modified transmission parameters and a current channel quality and/or current interference in communications between the network node and the UE. That is, the transmission parameters selected, scheduled, and used by the network node and/or the UE may be based on past interference measurement metrics that are outdated and/or expired, resulting in transmission parameters that are ineffective in mitigating current interference observed by the UE. Ineffective interference mitigation may result in increased data recovery errors, decreased data throughput, and/or increased data transfer latencies.

To avoid using outdated and/or expired interference data, a UE may use a machine learning model to predict interference. Examples of predicting interference may include predicting interference measurement metrics and/or interference characteristics, such as an interference power prediction, an interference covariance matrix (Rₙₙ)prediction, and/or a signal-to-interference-plus-noise ratio (SINR) prediction. Predicting interference may mitigate outdated and/or expired interference data, and may enable a network node to dynamically and preemptively optimize resource configurations that increase a quality of wireless communications (e.g., increased data throughput, decreased recovery errors, and/or decreased data transfer latencies).

A UE may be configured with multiple machine learning models that are configured to perform various respective functions, such as one or more interference prediction machine learning models, one or more beam prediction machine learning models, and/or one or more channel estimation prediction machine learning models. Relative to a network node, the UE may have fewer computational resources (e.g., fewer central processing units (CPUs), a smaller random-access memory (RAM) size, a smaller storage memory size, a smaller power supply, and/or a smaller operating system with less functionality). Accordingly, running the multiple machine learning models continuously and/or simultaneously may consume a disproportionate amount of the computational resources of the UE, resulting in the UE having fewer or no computation resources to perform other tasks. Alternatively, or additionally, running the multiple machine learning models continuously and/or simultaneously may drain the power supply (e.g., a battery) at the UE more quickly, resulting in a shorter operating life of the UE.

Various aspects relate generally to interference prediction events. Some aspects more specifically relate to a UE computing an interference prediction based at least in part on detecting an interference prediction event. In some aspects, a UE may detect that an interference prediction event that indicates to generate an interference prediction for a future air interface resource has occurred. Based at least in part on detecting that the interference prediction event has occurred, the UE may transmit an event-triggered interference prediction report that includes the interference prediction. For example, the UE may generate the interference prediction using a machine learning model that is trained to predict interference, and may include the interference prediction in the event-triggered interference prediction report.

In some aspects, a network node may receive an event-triggered interference prediction report that includes an interference prediction generated by a UE, and the event-triggered interference prediction report may be associated with an interference prediction event (e.g., the UE detecting an occurrence of the interference prediction event). Based at least in part on receiving the event-triggered interference prediction report, the network node may transmit an air interface resource allocation that is assigned to the UE, and the air interface resource allocation may be configured to mitigate interference that is indicated by the interference prediction. In some aspects, prior to receiving the event-triggered interference prediction report, the network node may transmit information that configures the UE to monitor for the interference prediction event.

Particular aspects of the subject matter described in this disclosure can be implemented to realize one or more of the following potential advantages. In some examples, by configuring a UE to monitor for an interference prediction event, the described techniques can be used to enable the UE to preserve computation resources and/or mitigate needless consumption of the computational resources. Preserving the computational resources may enable the UE to extend an operating life of the UE by reducing power consumption and/or may enable the UE to use the computational resources for other tasks. Alternatively, or additionally, configuring a UE to monitor for an interference prediction event may enable the UE to identify scenarios in which interference prediction may increase a quality of wireless communications. To illustrate, in a first scenario, interference variations observed at the UE may be significant (e.g., the variations may be associated with different optimal resource configurations), such that a current quality of wireless communications at the UE may be limited. The UE may be configured to detect the significant interference variations as an interference prediction event and, consequently, use a portion of the available computational resources to execute an interference prediction machine learning model that predicts interference on future resource(s). The UE may then transmit the interference predictions to a network node, and the network node may preemptively select a resource configuration that mitigates the predicted interference as described above. In a second scenario, interference variations observed by the UE may be less significant and/or small (e.g., the variations may be associated with a same optimal resource configuration), and the UE may preserve computational resources by not using the interference prediction machine learning model to predict interference on future resources. Instead, the UE may indicate measured interference to the network node.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

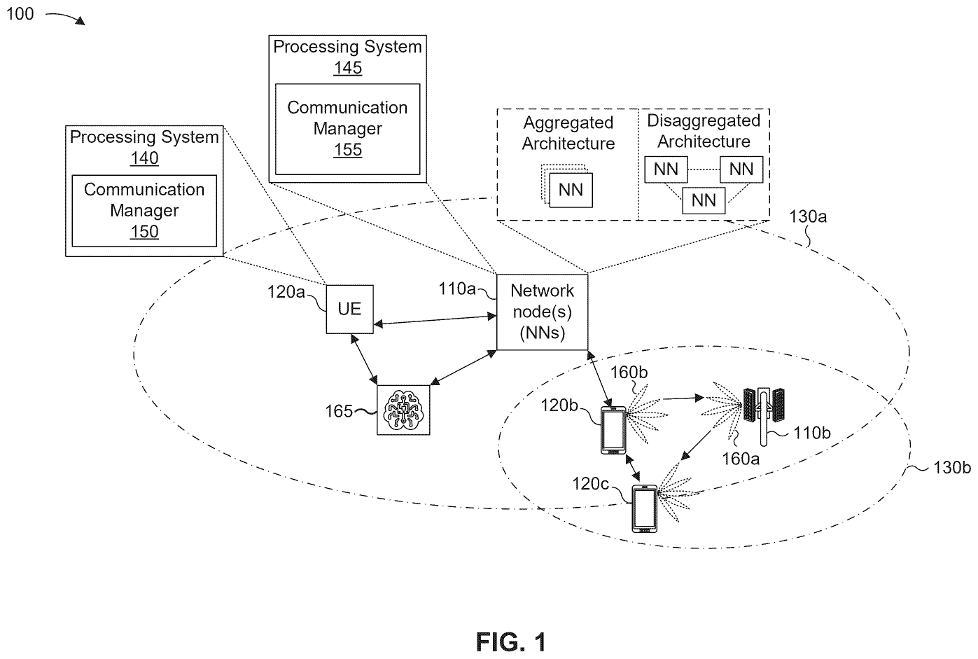

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

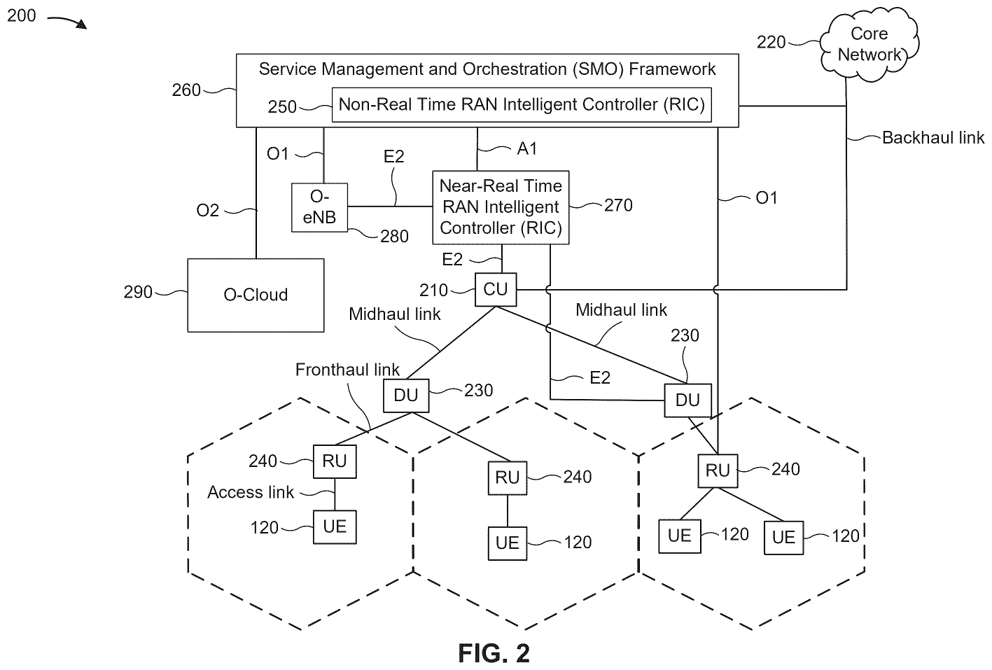

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., a UE 120) may include a communication manager 150. As described in more detail elsewhere herein, the communication manager 150 may detect that an interference prediction event that indicates to generate an interference prediction for a future air interface resource has occurred; and transmit, based at least in part on detecting that the interference prediction event has occurred, an event-triggered interference prediction report that includes the interference prediction. Additionally, or alternatively, the communication manager 150 may perform one or more other operations described herein.

In some aspects, a network node (e.g., a network node 110) may include a communication manager 155. As described in more detail elsewhere herein, the communication manager 155 may receive an event-triggered interference prediction report that includes an interference prediction generated by a UE, the event-triggered interference prediction report being associated with an interference prediction event; and transmit an air interface resource allocation that is assigned to the UE, the air interface resource allocation being configured to mitigate interference that is indicated by the interference prediction. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

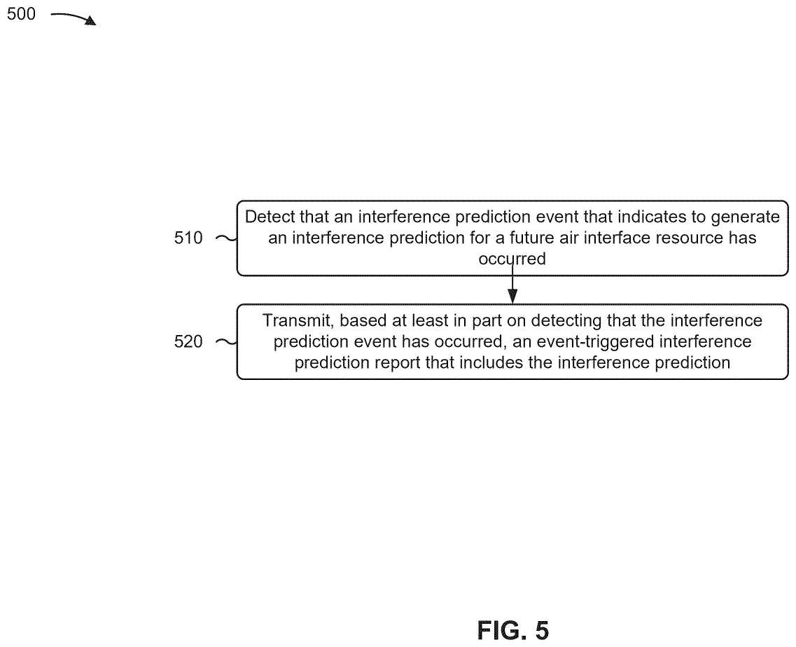

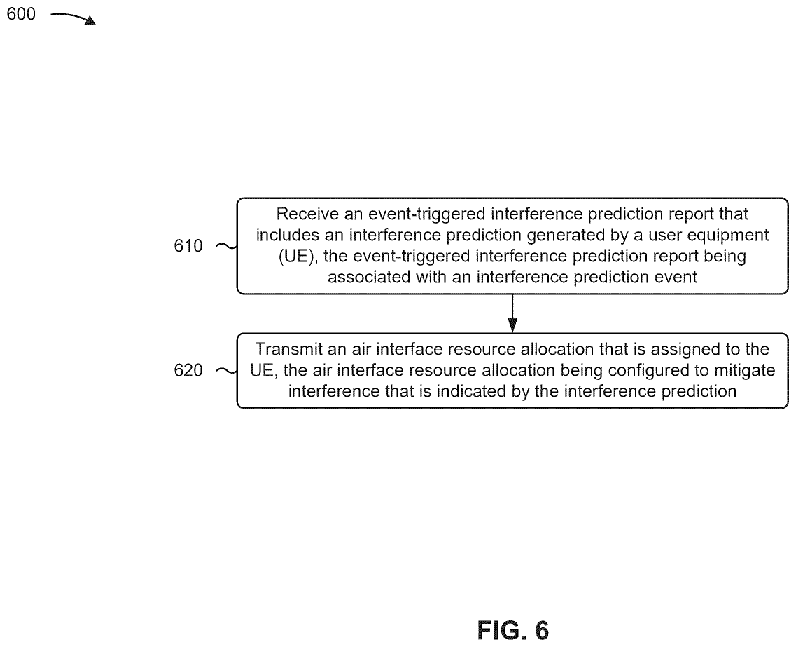

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with interference prediction events, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

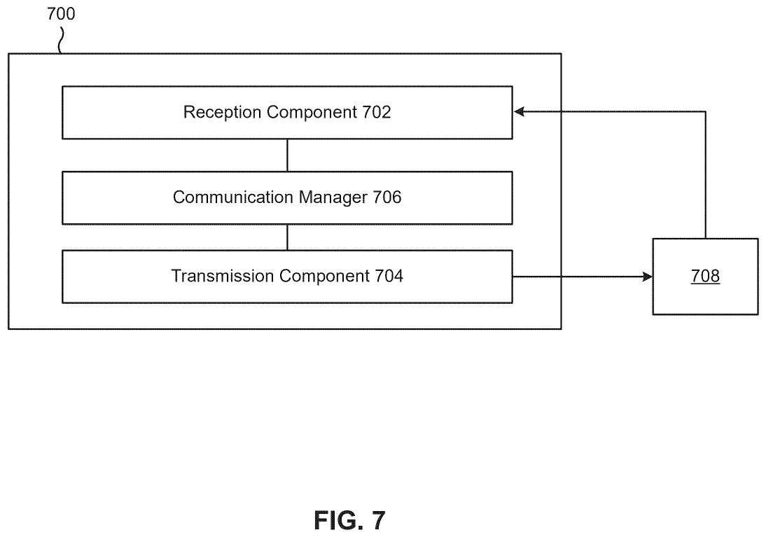

In some aspects, a UE (e.g., a UE 120) includes means for detecting that an interference prediction event that indicates to generate an interference prediction for a future air interface resource has occurred; and/or means for transmitting, based at least in part on detecting that the interference prediction event has occurred, an event-triggered interference prediction report that includes the interference prediction. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

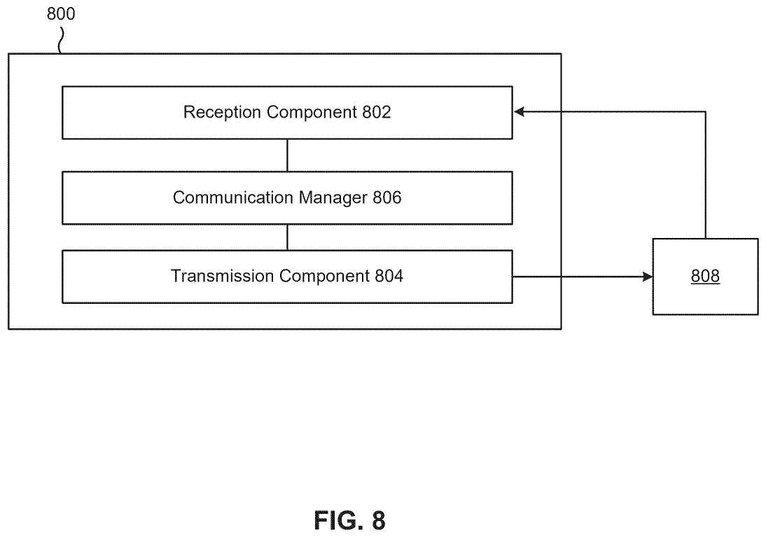

In some aspects, a network node (e.g., a network node 110) includes means for receiving an event-triggered interference prediction report that includes an interference prediction generated by a UE, the event-triggered interference prediction report being associated with an interference prediction event; and/or means for transmitting an air interface resource allocation that is assigned to the UE, the air interface resource allocation being configured to mitigate interference that is indicated by the interference prediction. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

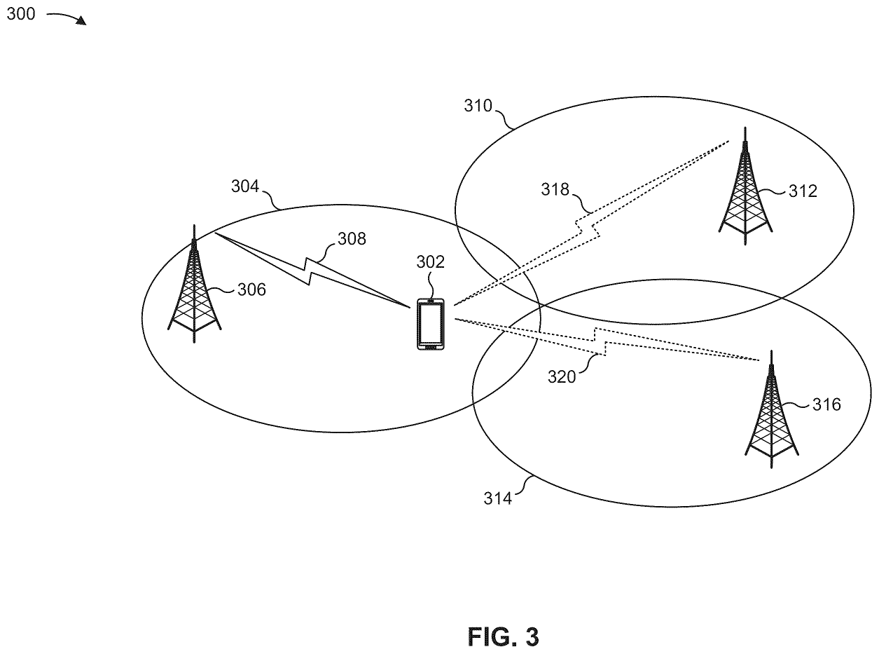

FIG. 3 is a diagram illustrating an example 300 of interference, in accordance with the present disclosure.

Interference in a wireless communication system is a disruption to a signal that may degrade a quality of the signal and/or communications conveyed by the signal, such as a disruption that reduces a signal-to-noise ratio (SNR) and/or increases recovery errors at a receiver. To illustrate, example 300 includes a UE 302 (e.g., a UE 120) that is located in a first cell coverage area 304 that is provided by a first network node 306 (e.g., a first network node 110). The UE 302 may communicate with the first network node 306 using wireless communications 308. The first cell coverage area 304 may border a second coverage area 310 that is provided by a second network node 312 and/or a third coverage area 314 that is provided by a third network node 316. Wireless communications 318 within the second cell coverage area 310 and/or wireless communications 320 in the third cell coverage area 314 may act as interference (e.g. inter-cell interference) to the wireless communications 308, resulting in reduced signal quality of the wireless communications 308, increased recovery errors, decreased data throughput, and/or increased data transfer latencies in the exchanges between the first network node 306 and the UE 302.

To mitigate interference, the UE 302 may generate one or more measurement metrics to estimate a channel quality and/or interference in a signal received by the UE 302. As one example, the UE 302 may use channel measurement resources (CMRs) to generate channel estimation measurement metrics, such as by using a CSI-RS resource to generate CQI, SNR, CSI, and/or RSRP. Alternatively, or additionally, the UE 302 may use interference measurement resources (IMRs) to generate interference measurement metrics, such as by using a CSI interference measurement (CSI-IM) to generate an interference SINR metric, an interference power metric, and/or a reference signal received interference power (RSRIP) metric. The measurement metrics may be used to modify transmission parameters (e.g., a beam configuration, an MCS, power control, and/or a transmission frequency allocation) in a manner that mitigates the interference. For instance, the UE 302 may transmit a report that indicates the channel estimation measurement metrics and/or the interference measurement metrics to the first network node 306, and the first network node 306 may modify one or more transmission parameters to mitigate the interference.

The selection, scheduling, and use of the modified transmission parameters (e.g., by the first network node 306 and/or the UE 302) may be delayed from when the UE 302 observes and generates the measurement metrics, and the delay may be large enough to cause a mismatch between the modified transmission parameters and a current channel quality and/or current interference in communications between the first network node 306 and the UE 302. To illustrate, changes in one or more configuration parameters at neighboring cells (e.g., the second coverage area 310 and/or the third coverage area 314) may impact and/or modify a temporal correlation, a frequency correlation, and/or a spatial correlation of inter-cell interference observed at the UE 302. Examples of configuration parameters that may affect inter-cell interference observed at a UE may include a scheduling behavior and/or scheduling type (e.g., proportional fair scheduling and/or round robin scheduling), a scheduling granularity (e.g., a mini-slot granularity, a slot granularity, and/or a multi-slot granularity), a number of active UEs in a neighboring cell, a traffic type in the neighboring cells, a loading configuration, a resource utilization (RU) configuration, beam management and/or a beam usage configuration, and/or a variation in a channel between interfering cells and the UE. Accordingly, the transmission parameters selected, scheduled, and used by the first network node 306 and/or the UE 302 may be based on past interference measurement metrics that are outdated and/or expired, resulting in transmission parameters that are ineffective in mitigating current interference observed by the UE 302 in the first cell coverage area 304. Ineffective interference mitigation may result in increased data recovery errors, decreased data throughput, and/or increased data transfer latencies.

To mitigate outdated and/or expired interference data, a UE may use a machine learning model to predict interference. Examples of predicting interference may include predicting interference measurement metrics and/or interference characteristics, such as an interference power prediction, an interference covariance matrix (Rₙₙ)prediction, and/or an SINR prediction. Interference in a signal typically differs in nature from the wireless channel through which the signal travels, and variations in the interference variation is typically larger and more dynamic than variations in the wireless channel. Accordingly, predicting interference may mitigate outdated and/or expired interference data, and may enable a network node to dynamically and preemptively optimize resource configurations (e.g., channel selection, power configurations, and/or scheduling) that increase a quality of wireless communications (e.g., increased data throughput, decreased recovery errors, and/or decreased data transfer latencies). That is, interference prediction and reporting from a UE to a network node may enable the network node to select an optimal resource configuration (e.g., a beam configuration, an MCS, a rank, power control, and/or a transmission frequency allocation) in advance for a future resource to increase the quality of the wireless communications relative to a quality associated with using outdated and/or expired interference information. As another example, the network node may exclude, from a resource allocation, one or more resources that the predicted information indicates are expected to have high interference (e.g., predicted interference that satisfies a high interference threshold). In some aspects, the network node may adapt a reference signal configuration based at least in part on predicted interference, such as by reducing a power level of a reference signal, assigning the reference signal to a different frequency band or subcarrier, and/or changing a beam configuration of a beam that carries the reference signal, to mitigate interference in other cells.

The use of a machine learning model may simplify an interference prediction algorithm that is implemented at a UE relative to a static algorithm that is based at least in part on an analytical model. To illustrate, inter-cell interference may be based at least in part on a large variety of factors, examples of which are provided above, making analytical modeling of interference prediction complex and difficult to implement (e.g., high computational complexity, a lack of adaptability, complex mathematical dependencies, and/or poor scalability). A machine learning model may be trained using a variety of interference variation patterns observed in previous resources, resulting in an interference prediction algorithm with reduced complexity (e.g., lower computational complexity, more adaptability, fewer complex mathematical dependencies, and/or increased scalability) relative to a static algorithm that is based at least in part on an analytical model. For example, a machine learning model may be trained to receive a set of interference measurements that are based at least in part on a set of previous resources (e.g., beam resources, slot resources, and/or sub-bands) as input, and the machine learning model may output predicted interference on a set of future resources. The set of interference measurements and/or the set of previous resources may vary in time (e.g., slots), space (e.g., beams), and/or frequency (e.g., sub-bands). A machine learning mode may be based on a variety of machine learning algorithms, such as a deep neural network (e.g., a recurrent neural network (RNN), a convolutional neural network (CNN), and/or a transformer), a classical machine learning model (e.g., supported vector machines (SVM), random forest, and/or K-nearest neighbors (KNN)), an autoregressive approach, and/or a minimum mean square error (MMSE) predictor approach.

A UE may be configured with multiple machine learning models that are configured to perform various respective functions, such as one or more interference prediction machine learning models, one or more beam prediction machine learning models, and/or one or more channel estimation prediction machine learning models. Relative to a network node, the UE may have fewer computational resources (e.g., fewer CPUs, a smaller RAM size, a smaller storage memory size, a smaller power supply, and/or a smaller operating system with less functionality). Accordingly, running the multiple machine learning models continuously and/or simultaneously may consume a disproportionate amount of the computational resources of the UE, resulting in the UE having fewer or no computation resources to perform other tasks. Alternatively, or additionally, running the multiple machine learning models continuously and/or simultaneously may drain the power supply (e.g., a battery) at the UE more quickly, resulting in a shorter operating life of the UE.

Various aspects relate generally to interference prediction events. Some aspects more specifically relate to a UE computing an interference prediction based at least in part on detecting an interference prediction event. In some aspects, a UE may detect that an interference prediction event that indicates to generate an interference prediction for a future air interface resource has occurred. Based at least in part on detecting that the interference prediction event has occurred, the UE may transmit an event-triggered interference prediction report that includes the interference prediction. For example, the UE may generate the interference prediction using a machine learning model that is trained to predict interference, and may include the interference prediction in the event-triggered interference prediction report.

In some aspects, a network node may receive an event-triggered interference prediction report that includes an interference prediction generated by a UE, and the event-triggered interference prediction report may be associated with an interference prediction event (e.g., the UE detecting an occurrence of the interference prediction event). Based at least in part on receiving the event-triggered interference prediction report, the network node may transmit an air interface resource allocation that is assigned to the UE, and the air interface resource allocation may be configured to mitigate interference that is indicated by the interference prediction. In some aspects, prior to receiving the event-triggered interference prediction report, the network node may transmit information that configures the UE to monitor for the interference prediction event.

Particular aspects of the subject matter described in this disclosure can be implemented to realize one or more of the following potential advantages. In some examples, by configuring a UE to monitor for an interference prediction event, the described techniques can be used to enable the UE to preserve computation resources and/or mitigate needless consumption of the computational resources. Preserving the computational resources may enable the UE to extend an operating life of the UE by reducing power consumption and/or may enable the UE to use the computational resources for other tasks. Alternatively, or additionally, configuring a UE to monitor for an interference prediction event may enable the UE to identify scenarios in which interference prediction may increase a quality of wireless communications. To illustrate, in a first scenario, interference variations observed at the UE may be significant (e.g., the variations may be associated with different optimal resource configurations), such that a current quality of wireless communications at the UE may be limited. The UE may be configured to detect the significant interference variations as an interference prediction event and, consequently, use a portion of the available computational resources to execute an interference prediction machine learning model that predicts interference on future resource(s). The UE may then transmit the interference predictions to a network node, and the network node may preemptively select a resource configuration that mitigates the predicted interference as described above. In a second scenario, interference variations observed by the UE may be less significant and/or small (e.g., the variations may be associated with a same optimal resource configuration), and the UE may preserve computational resources by not using the interference prediction machine learning model to predict interference on future resources. Instead, the UE may indicate measured interference to the network node.

As indicated above, FIG. 3 is provided as an example. Other examples may differ from what is described with regard to FIG. 3.

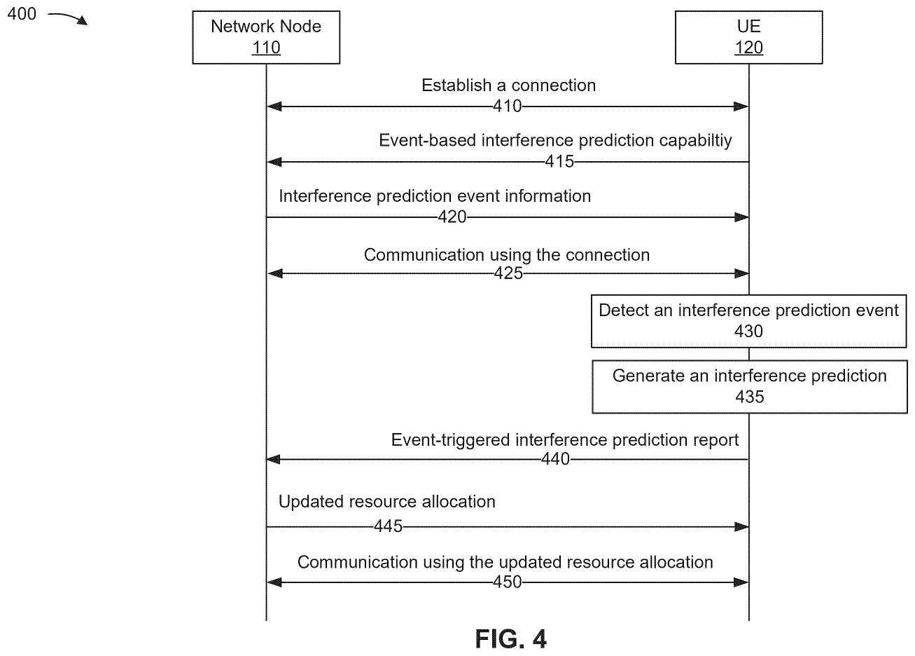

FIG. 4 is a diagram illustrating an example 400 of a wireless communication process between a network node (e.g., the network node 110) and a UE (e.g., the UE 120), in accordance with the present disclosure.

As shown by reference number 410, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information, and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays.

As shown by reference number 415, the UE 120 may transmit, and the network node 110 may receive, an indication of an event-based interference prediction capability. As one example of an event-based interference prediction capability, the UE 120 may indicate support for event-driven interference predictions. Alternatively, or additionally, the UE 120 may indicate one or more interference prediction events that are supported by the UE 120. In a scenario that includes a communication standard specifying one or more interference prediction algorithms, the UE 120 may indicate one or more interference prediction algorithms that are supported by the UE 120. For instance, the communication standard may specify multiple interference prediction algorithms, interference prediction functionality, and/or interference prediction output(s). The communication standard may also specify a respective identifier (ID) for each interference prediction algorithm, interference prediction functionality, and/or interference prediction output(s), and the UE 120 may specify each respective ID of the interference prediction algorithms (e.g., an interference prediction algorithm ID), interference prediction functionality, and/or interference prediction outputs that are supported by the UE 120. In other scenarios, a communication standard may not specify any interference prediction algorithms, interference prediction functionality, and/or interference prediction outputs.

For clarity, FIG. 4 illustrates the UE 120 transmitting the indication of the event-based interference prediction capability in a separate transaction than establishing a connection with the network node 110. However, in some aspects, the UE 120 may transmit the indication of an event-based interference prediction capability as part of establishing a connection with the network node 110.

As shown by reference number 420, the network node 110 may transmit, and the UE 120 may receive, interference prediction event information. To illustrate, the network node 110 may transmit information that configures the UE 120 to monitor for one or more interference prediction events and/or to generate an interference prediction based at least in part on the UE 120 detecting an occurrence of a particular interference prediction event. For example, the network node 110 may indicate one or more interference prediction events, such as any combination of a first event that includes a measurement metric satisfying a first trigger threshold, a second event that includes a first interference metric generated using a non-serving beam of the UE being lower than a second interference metric generated using a serving beam of the UE, a third event that includes a first SINR metric generated using the non-serving beam of the UE being higher than a second SINR metric generated using the serving beam of the UE, and/or a fourth event that includes an interference variation between at least two air interface resources satisfying a second trigger threshold. An interference prediction event may be based at least in part on a Layer 1 measurement metric, a Layer 2 measurement metric, and/or a Layer 3 measurement metric. Alternatively, or additionally, each interference prediction event may be associated with a respective threshold. To illustrate, a first interference prediction event may be based at least in part on a Layer 1 interference power measurement satisfying a first trigger threshold, and a second interference prediction event may be based at least in part on a Layer 1 SINR measurement metric satisfying a second trigger threshold. Alternatively, or additionally, an interference prediction event may be associated with multiple air interface resources that are based at least in part on any combination of multiple time partitions (e.g., multiple slots, multiple mini-slots, and/or multiple symbols), multiple beams, and/or multiple frequency partitions (e.g., carrier sub-bands). For instance, a third interference prediction event may be associated with the interference variation between interference observed in at least two air interface resources satisfying a trigger threshold, and the at least two air interface resources may be in different time partitions (e.g., slots, mini-slots, and/or symbols), may be associated with different beams, and/or may be located in different frequency partitions (e.g., sub-bands, bands, and/or carrier frequencies). In some aspects, the network node may indicate one or more configuration values associated with the interference prediction events, such as a first configuration value for a first trigger threshold and/or a second configuration value for a second trigger threshold.

Alternatively, or additionally, the network node 110 may specify an interference prediction event that is based at least in part on a statistical computation. That is, the interference prediction event may be based at least in part on multiple measurement metrics, rather than a single measurement metric, to ensure a more robust interference prediction event. As one example, the network node 110 may specify an interference prediction event that is based at least in part on a variance and/or a different statistical property satisfying a trigger threshold, and the variance and/or different statistical property may be based at least in part on multiple measurement metrics (e.g., multiple Layer 1 SINR metrics and/or multiple Layer 1 interference power metrics). Examples of statistical properties may include a mean, a mode, a 95^{th} percentile, and/or a higher order moment. As a second example, the network node 110 may specify an interference prediction event that is based at least in part on a percentage of a set of interference measurement metrics computed by the UE 120 (e.g., 50%, 75%, and/or 80%) satisfying a trigger threshold. The network node 110 may indicate a number of interference measurement metrics to use for generating the statistical computation and/or may indicate the percentage.

The indication of the interference prediction event(s) may implicitly instruct the UE 120 to begin monitoring for the indicated interference prediction event(s). Alternatively, the network node 110 may separately transmit (e.g., in different signaling than the information) an instruction to begin monitoring for the interference prediction events and/or to cease monitoring for the interference prediction events. For instance, the network node 110 may indicate multiple interference prediction events in Layer 3 signaling (e.g., RRC signaling), and may instruct the UE 120 to begin monitoring for a particular interference prediction event in Layer 1 signaling (e.g., DCI) and/or Layer 2 signaling (e.g., a MAC CE). Accordingly, the network node 110 may transmit separate signaling that selects a particular interference prediction event out of multiple interference prediction events, and the selection of the particular interference prediction event may (or may not) implicitly indicate to begin monitoring for the particular interference prediction event.

One or more interference prediction event(s) indicated by the network node 110 may be specified by a communication standard. For instance, the communication standard may specify one or more interference prediction events and/or may map a respective ID to each interference prediction event. Accordingly, the network node 110 may configure the UE 120 with one or more interference prediction event(s) by indicating the respective interference prediction event IDs that are specified by the communication standard. In some aspects, the network node 110 may indicate an association between an interference prediction event and an interference prediction algorithm. To illustrate, the network node 110 may indicate to generate a first interference prediction using a first interference algorithm based at least in part on detecting a first interference prediction event, and/or may indicate to generate a second interference prediction using a second interference algorithm based at least in part on detecting a second interference prediction event. The ability to associate an interference prediction event with an interference prediction algorithm may enable the network node 110 to configure a type of interference prediction information that is reported to the network node 110 for a particular interference prediction event, and the type of interference prediction information may enable the network node 110 to select more optimal transmission parameters.

Alternatively, or additionally, as part of the interference prediction event information, the network node 110 may transmit an interference prediction configuration and/or information that instructs the UE 120 to update a machine learning model using the interference prediction configuration. In some aspects, the network node 110 may indicate multiple interference prediction configurations and may instruct the UE 120 to use a respective interference prediction configuration to update a respective interference prediction algorithm (e.g., a machine learning model) that generates an interference prediction. Accordingly, each interference prediction configuration may be associated with and/or linked to an interference prediction model ID (e.g., a machine learning model ID) and/or interference prediction model functionality (e.g., machine learning functionality). The network node 110 may indicate the association as a parameter in the interference prediction event information, and the association may indicate to use the interference prediction configuration for a particular machine learning model.

Alternatively, or additionally, an interference prediction configuration may be associated with a particular interference prediction event. To illustrate, the network node 110 may instruct the UE 120 to use the interference prediction configuration to update a machine learning model based at least in part on detecting an occurrence of the particular interference prediction event. However, in other examples, the interference prediction configuration may not be associated with a particular interference prediction event. For instance, the network node 110 may instruct the UE 120 (e.g., implicitly or explicitly) to apply the interference prediction configuration to an interference prediction algorithm prior to detecting the occurrence of an interference prediction event.

In some aspects, the interference prediction configuration may indicate an interference prediction time window (e.g., a window in time during which the predicted interference is expected to occur, such as a starting symbol and an ending symbol of the predicted interference, or other types of time partitions). Alternatively, or additionally, the interference prediction configuration may indicate an interference prediction sampling rate. For example, the interference prediction sampling rate may specify to generate a predicted interference power level every slot or every X slots, although the interference prediction sampling rate may be based at least in part on other types of time partitions (e.g., a mini-slot and/or a symbol). In some aspects, the interference prediction configuration may indicate an interference prediction resource resolution, such as by indicating a grouping of resources for the predicted interference (e.g., a slot-level interference prediction, a symbol-level interference prediction, and/or a multi-slot interference prediction). Other examples of resource resolution indicated by the interference prediction configuration may include a wideband resource resolution (e.g., wideband interference prediction), a sub-band resource resolution (e.g., a sub-band interference prediction), and/or a resource block (RB) resource resolution (e.g., an RB interference prediction). In some aspects, the resource resolution may indicate a number of resources, such as a number of sub-bands to use for the sub-band interference prediction and/or a number of RBs to use for the RB interference prediction.

Other examples may include the interference prediction configuration indicating an interference prediction beam configuration, an interference prediction pattern configuration, an interference prediction bandwidth resolution, a number of sub-band interference predictions, a prediction metric type, an interference autocorrelation matrix prediction resolution, and/or an interference prediction algorithm type. To illustrate, an interference prediction beam configuration may indicate one or more beam parameters to use for generating the interference prediction, such as a number of beams, a beam ID, and/or a spatial sampling rate for generating an interference prediction (e.g., an interference prediction sampling in space). The number of beams and/or the beam ID may be indicated through a CSI-RS resource indicator (CRI) and/or an SSB resource indicator (SSB-RI). Accordingly, an interference prediction beam configuration may indicate to generate an interference prediction for one or more beam resources.

An interference prediction pattern configuration may indicate a temporal interference prediction pattern (e.g., only a time-based interference prediction pattern) and/or a temporal-spatial interference prediction pattern (e.g., a time-based and spatially-based interference prediction pattern). That is, the interference prediction pattern configuration may indicate to generate an interference prediction in resources that are associated with the temporal interference prediction pattern and/or the temporal-spatial interference pattern.

An interference autocorrelation matrix prediction resolution in an interference prediction configuration may indicate what resolution of an interference autocorrelation matrix to generate as at least part of an interference prediction. To illustrate, the interference prediction configuration may indicate, as an interference autocorrelation matrix prediction resolution, any combination of a trace resolution, a diagonal resolution, and/or a full matrix resolution.

In some aspects, the network node 110 may indicate, as an interference prediction algorithm type to use for generating an interference prediction, a machine learning model algorithm or a statistical computation algorithm. For instance, in some scenarios (e.g., when interference variations are not significant and/or when the performance is not interference-limited), the network node 110 may indicate to use a lower complexity algorithm (e.g., a statistical computation algorithm) for interference prediction, such as a sample and hold algorithm, an average of past interference measurement, and/or an minimum mean square error (MMSE) algorithm. In other scenarios (e.g., high interference variations and/or performance being interference-limited), the network node 110 may indicate to use a machine learning model algorithm. Alternatively, or additionally, the network node 110 may specify, as a prediction metric type, an interference power prediction metric type and/or an SINR prediction metric type (e.g., an interference SINR prediction metric type). That is, the indication of a prediction metric type may instruct the UE 120 to generate interference prediction(s) that include the prediction metric type (e.g., an interference power prediction and/or an SINR prediction).

By indicating an interference prediction configuration, the network node 110 may change how often a UE 120 generates an interference prediction and/or an amount of information generated by the UE 120 to further preserve computational resources at the UE 120. To illustrate, for a first scenario, interference variations that occur within a set of time partitions (e.g., slots, mini-slots and/or symbols) may be small and/or may satisfy a small change threshold. In the first scenario, the network node 110 may configure the UE 120, via the interference prediction configuration, to generate an interference prediction using a long sampling interval that spans multiple time partitions (e.g., four slots). For a second scenario, the interference variations that occur within the same set of time partitions may be large and/or may satisfy a large change threshold. In the second scenario, the network node 110 may configure the UE 120, via the interference prediction configuration, to generate an interference prediction using a short sampling interval that spans a single time partition (e.g., one slot). The ability to change how often the UE 120 generates an interference prediction and/or an amount of information may enable the network node to balance preserving computational resources at the UE 120 with acquiring interference predictions that enable the network node to mitigate interference using optimal transmission parameters. Alternatively, or additionally, the network node 110 may reduce signaling overhead by reducing an amount of reporting by the UE 120, which may preserve air interface resources for other purposes and/or may preserve computational resources at the UE 120 as described above.

As shown by reference number 425, the network node 110 and the UE 120 may communicate using the connection. For example, the network node 110 may transmit, and the UE 120 may receive, a downlink signal using the connection. Alternatively, or additionally, the UE 120 may transmit, and the network node 110 may receive, an uplink signal using the connection.

As shown by reference number 430, the UE 120 may detect an interference prediction event. For instance, the UE 120 may compute that a measurement metric satisfies a first trigger threshold, that a first interference metric generated using a non-serving beam (e.g., of the UE 120) is lower than a second interference metric generated using a serving beam (e.g., of the UE 120), that a first SINR measurement metric generated using the non-serving beam is higher than a second SINR metric generated using the serving beam, and/or that an interference variation between at least two air interface resources satisfies a second trigger threshold. In some aspects, the interference prediction event and/or detecting an occurrence of the interference prediction may be based at least in part on a statistical computation that uses multiple measurement metrics as described above with regard to reference number 420. Accordingly, the UE 120 may generate multiple measurement metrics, and use the multiple measurement metrics in the statistical computation.

As shown by reference number 435, the UE 120 may generate an interference prediction based at least in part on detecting an occurrence of an interference prediction event. For example, the UE 120 may generate the interference prediction using a machine learning model that is trained to predict interference. In some aspects, the UE 120 may update the machine learning model prior to generating the interference prediction, such as by updating the machine learning model using an interference prediction configuration indicated by the network node 110, as described with regard to reference number 420. As one example, the UE 120 may detect the occurrence of an interference prediction event, update the machine learning model using an interference prediction configuration, and generate an interference prediction using the updated machine learning model. However, in other aspects, the UE 120 may update the machine learning model based at least in part on receiving an indication of the interference prediction configuration and/or prior to detecting the occurrence of an interference prediction event, such as during an idle period.

As shown by reference number 440, the UE 120 may transmit, and the network node 110 may receive, an event-triggered interference prediction report. The event-triggered interference prediction report may include any type of interference prediction, such as a predicted interference measurement metric and/or at least a portion of an interference autocorrelation matrix as described above. While shown in FIG. 4 as a single signaling transaction from the UE 120 to the network node 110, some examples may include multiple signaling transactions between the UE 120 and the network node 110.

As one example, the UE 120 may initially transmit an event-detected indication that indicates that the UE 120 has detected an occurrence of an interference prediction event. To illustrate, the UE 120 may set a one-bit bitflag to a value (e.g., “1”) that indicates that the UE 120 has detected an occurrence of an interference prediction event. The one-bit flag may be included in Layer 1 signaling (e.g., UCI), Layer 2 signaling (e.g., a MAC CE), and/or Layer 3 signaling (e.g., RRC signaling). Alternatively, or additionally, the UE 120 may set a particular bit of a bitmap to the value to indicate that the UE 120 has detected an occurrence of a particular interference prediction event. For instance, each bit in the bitmap may be mapped to a respective interference prediction event, and the UE 120 may set the particular bit that maps to the detected interference prediction event to the value. In some aspects, the network node 110 may configure the mapping of the bitmap to respective interference prediction events, and the bitmap may be included in Layer 1 signaling (e.g., UCI), Layer 2 signaling (e.g., a MAC CE), and/or Layer 3 signaling (e.g., RRC signaling).

Based at least in part on receiving the event-detected indication, the network node 110 may transmit, and the UE 120 may receive, a dynamic uplink grant that is configured for the event-triggered interference prediction report. The network node 110 may schedule the UE, via the dynamic uplink grant, with PUCCH resources and/or PUSCH resources for the event-triggered interference prediction report. Accordingly, the UE 120 may transmit the event-triggered interference prediction report using the dynamic uplink grant.

In other examples, the UE 120 may receive, from the network node 110, a static uplink grant that is allocated to transmitting an event-driven interference prediction report. To illustrate, the network node 110 may preschedule (e.g., prior to the UE 120 detecting an interference prediction event) the UE 120 with one or more PUCCH resources that are designated for an event-triggered interference prediction report. As another example, the network node 110 may transmit a configured grant (e.g., a PUSCH configured grant) that is assigned to the UE 120 for an event-triggered interference prediction report, such as by transmitting an indication of the configured grant during a procedure to establish the connection with the UE 120. Based at least in part on detecting the occurrence of an interference prediction event, the UE 120 may use the static uplink grant, such as the prescheduled PUCCH resources and/or the PUSCH configured grant, to transmit the event-triggered interference prediction report. In some aspects, the UE 120 may transmit an event-triggered interference prediction report in air interface resources that are based at least in part on a time delay (e.g., X milliseconds and/or Y slots) that is based at least in part on reception of a reference signal (e.g., a CSI-RS and/or SSB) that is associated with the UE 120 detecting the occurrence of the interference prediction event.

The UE 120 may transmit an event-triggered interference prediction report based at least in part on receiving a report activation instruction from the network node 110. For example, the network node 110 may transmit the report activation instruction (e.g., for activating the transmission of event-triggered interference prediction reports) in Layer 1 signaling (e.g., DCI) and/or Layer 2 signaling (e.g., a MAC CE). As another example, the UE 120 may not transmit the event-triggered interference prediction report based at least in part on receiving a report deactivation instruction from the network node 110 (e.g., via Layer 1 signaling and/or Layer 2 signaling). In some aspects, an event-triggered interference prediction report may be associated with a component carrier (CC), a CC group, and/or a frequency band, and the network node 110 may activate and/or deactivate a particular event-triggered interference prediction report that is associated with a particular CC, a particular CC group, and/or a particular band. For instance, the network node 110 may activate a first event-triggered interference prediction report that is associated with a first CC, and may deactivate a second event-triggered interference prediction report that is associated with a second CC. Accordingly, the UE 120 may generate and/or transmit multiple event-triggered interference prediction reports as instructed by the network node 110.

As shown by reference number 445, the network node 110 may transmit, and the UE 120 may receive, an updated air interface resource allocation. To illustrate, based at least in part on an interference prediction (e.g., a predicted interference measurement metric), the network node 110 may update a beam configuration, an MCS, power control, and/or a transmission frequency of an air interface resource allocation that is assigned to the UE 120, and indicate the update(s) as at least part of the updated air interface resource allocation.

As shown by reference number 450, the network node 110 and the UE 120 may communicate using the updated air interface resource allocation. To illustrate, the network node 110 may transmit a downlink communication using an updated MCS indicated in the updated air interface resource allocation. As another example, the UE 120 may transmit an uplink communication using an updated beam configuration indicated in the updated air interface resource allocation.

By configuring a UE to monitor for an interference prediction event, a network node may enable the UE to preserve computation resources and/or mitigate needless consumption of the computational resources. Preserving the computational resources may extend an operating life of the UE by reducing power consumption by the UE. Alternatively or additionally, the UE may use the computational resources for other tasks, resulting in decreased data transfer latencies and/or increased data throughput.

As indicated above, FIG. 4 is provided as an example. Other examples may differ from what is described with regard to FIG. 4.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with interference prediction events.

As shown in FIG. 5, in some aspects, process 500 may include detecting that an interference prediction event that indicates to generate an interference prediction for a future air interface resource has occurred (block 510). For example, the UE (e.g., using communication manager 706, depicted in FIG. 7) may detect that an interference prediction event that indicates to generate an interference prediction for a future air interface resource has occurred, as described above.

As further shown in FIG. 5, in some aspects, process 500 may include transmitting, based at least in part on detecting that the interference prediction event has occurred, an event-triggered interference prediction report that includes the interference prediction (block 520). For example, the UE (e.g., using transmission component 704 and/or communication manager 706, depicted in FIG. 7) may transmit, based at least in part on detecting that the interference prediction event has occurred, an event-triggered interference prediction report that includes the interference prediction, as described above.

Process 500 may include additional aspects, such as any single aspect or any combination of aspects described below and/or in connection with one or more other processes described elsewhere herein.

In a first aspect, the interference prediction event includes at least one of a measurement metric satisfying a first trigger threshold, a first interference metric generated using a non-serving beam of the UE being lower than a second interference metric generated using a serving beam of the UE, a first SINR metric generated using the non-serving beam of the UE being higher than a second SINR metric generated using the serving beam of the UE, or an interference variation between at least two air interface resources satisfying a second trigger threshold.

In a second aspect, process 500 includes receiving, prior to detecting the interference prediction event, information that configures the UE to monitor for the interference prediction event.

In a third aspect, the interference prediction event is specified by a communication standard.

In a fourth aspect, process 500 includes generating the interference prediction using a machine learning model that is trained to predict interference.

In a fifth aspect, the interference prediction event is based at least in part on a statistical computation that uses multiple measurement metrics.

In a sixth aspect, process 500 includes updating, based at least in part on detecting that the interference prediction event has occurred, a machine learning model using an interference prediction configuration, the machine learning model being trained to predict interference.

In a seventh aspect, the interference prediction configuration includes at least one of an interference prediction time window, an interference prediction sampling rate, an interference prediction resource resolution, an interference prediction beam configuration, an interference prediction pattern configuration, an interference prediction bandwidth resolution, a number of sub-band interference predictions, a prediction metric type, an interference autocorrelation matrix prediction resolution, or an interference prediction algorithm type.

In an eighth aspect, the interference prediction beam configuration indicates one or more parameters to use for generating the interference prediction, the one or more parameters including at least one of a number of beams, a beam identifier, or a spatial sampling rate.

In a ninth aspect, the interference prediction pattern configuration includes at least one of a temporal interference prediction pattern, or a temporal-spatial interference prediction pattern.

In a tenth aspect, the interference autocorrelation matrix prediction resolution includes a trace resolution of an interference autocorrelation matrix, a diagonal resolution of the interference autocorrelation matrix, or a full matrix resolution of the interference autocorrelation matrix.

In an eleventh aspect, the interference prediction algorithm type includes a machine learning model algorithm, or a statistical computation algorithm.

In a twelfth aspect, the prediction metric type includes at least one of an interference power prediction metric type, or an SINR ratio prediction metric type.

In a thirteenth aspect, process 500 includes transmitting an event-detected indication that indicates the detecting of the interference prediction event, receiving a dynamic uplink grant that is configured for the event-triggered interference prediction report, and transmitting the event-triggered interference prediction report includes transmitting the event-triggered interference prediction report using the dynamic uplink grant.

In a fourteenth aspect, process 500 includes receiving a static uplink grant that is allocated to reporting an interference prediction, and transmitting the event-triggered interference prediction report includes transmitting the event-triggered interference prediction report using the static uplink grant.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with interference prediction events.

As shown in FIG. 6, in some aspects, process 600 may include receiving an event-triggered interference prediction report that includes an interference prediction generated by a UE, the event-triggered interference prediction report being associated with an interference prediction event (block 610). For example, the network node (e.g., using reception component 802 and/or communication manager 806, depicted in FIG. 8) may receive an event-triggered interference prediction report that includes an interference prediction generated by a UE, the event-triggered interference prediction report being associated with an interference prediction event, as described above.

As further shown in FIG. 6, in some aspects, process 600 may include transmitting an air interface resource allocation that is assigned to the UE, the air interface resource allocation being configured to mitigate interference that is indicated by the interference prediction (block 620). For example, the network node (e.g., using transmission component 804 and/or communication manager 806, depicted in FIG. 8) may transmit an air interface resource allocation that is assigned to the UE, the air interface resource allocation being configured to mitigate interference that is indicated by the interference prediction, as described above.

Process 600 may include additional aspects, such as any single aspect or any combination of aspects described below and/or in connection with one or more other processes described elsewhere herein.

In a first aspect, the interference prediction event includes at least one of a measurement metric satisfying a first trigger threshold, a first interference metric generated using a non-serving beam of the UE being lower than a second interference metric generated using a serving beam of the UE, a first SINR metric generated using the non-serving beam of the UE being higher than a second SINR metric generated using the serving beam of the UE, or an interference variation between at least two air interface resources satisfying a second trigger threshold.

In a second aspect, the interference prediction event is specified by a communication standard.

In a third aspect, the interference prediction event is based at least in part on a statistical computation that uses multiple measurement metrics.

In a fourth aspect, process 600 includes transmitting information that configures the UE to monitor for the interference prediction event.

In a fifth aspect, the information configures the UE to update, based at least in part on detecting that the interference prediction event has occurred, a machine learning model using an interference prediction configuration, the machine learning model being trained to predict interference.

In a sixth aspect, the interference prediction configuration includes at least one of an interference prediction time window, an interference prediction sampling rate, an interference prediction resource resolution, an interference prediction beam configuration, an interference prediction pattern configuration, an interference prediction bandwidth resolution, a number of sub-band interference predictions, a prediction metric type, an interference autocorrelation matrix prediction resolution, or an interference prediction algorithm type.

In a seventh aspect, the interference prediction beam configuration indicates one or more parameters to use for generating the interference prediction, the one or more parameters including at least one of a number of beams, a beam identifier, or a spatial sampling rate.

In an eighth aspect, the interference prediction pattern configuration includes at least one of a temporal interference prediction pattern, or a temporal-spatial interference prediction pattern.

In a ninth aspect, the interference autocorrelation matrix prediction resolution includes a trace resolution of an interference autocorrelation matrix, a diagonal resolution of the interference autocorrelation matrix, or a full matrix resolution of the interference autocorrelation matrix.

In a tenth aspect, the interference prediction algorithm type includes a machine learning model algorithm, or a statistical computation algorithm.

In an eleventh aspect, the prediction metric type includes at least one of an interference power prediction metric type, or an SINR prediction metric type (e.g., an interference SINR prediction metric).

In a twelfth aspect, process 600 includes receiving an event-detected indication that indicates the interference prediction event has been detected, and transmitting a dynamic uplink grant that is assigned to the UE and is configured for the event-triggered interference prediction report, and receiving the event-triggered interference prediction report includes receiving the event-triggered interference prediction report using the dynamic uplink grant.

In a thirteenth aspect, process 600 includes transmitting a static uplink grant that is allocated to the UE for reporting an interference prediction, and receiving the event-triggered interference prediction report includes receiving the event-triggered interference prediction report using the static uplink grant.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 3-4. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The communication manager 706 may detect that an interference prediction event that indicates to generate an interference prediction for a future air interface resource has occurred. The transmission component 704 may transmit, based at least in part on detecting that the interference prediction event has occurred, an event-triggered interference prediction report that includes the interference prediction. In some aspects, the reception component 702 may receive, prior to detecting the interference prediction event, information that configures the UE to monitor for the interference prediction event.

The communication manager 706 may generate the interference prediction using a machine learning model that is trained to predict interference. Alternatively, or additionally, the communication manager 706 may update, based at least in part on detecting that the interference prediction event has occurred, a machine learning model using an interference prediction configuration, the machine learning model being trained to predict interference.

The transmission component 704 may transmit an event-detected indication that indicates the detecting of the interference prediction event. In some aspects, the reception component 702 may receive a dynamic uplink grant that is configured for the event-triggered interference prediction report. Alternatively, or additionally, the reception component 702 may receive a static uplink grant that is allocated to reporting an interference prediction.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 3-4. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive an event-triggered interference prediction report that includes an interference prediction generated by a UE, the event-triggered interference prediction report being associated with an interference prediction event. The transmission component 804 may transmit an air interface resource allocation that is assigned to the UE, the air interface resource allocation being configured to mitigate interference that is indicated by the interference prediction.

The transmission component 804 may transmit information that configures the UE to monitor for the interference prediction event. In some aspects, the reception component 802 may receive an event-detected indication that indicates the interference prediction event has been detected.

The transmission component 804 may transmit a dynamic uplink grant that is assigned to the UE and is configured for the event-triggered interference prediction report. Alternatively, or additionally, the transmission component 804 may transmit a static uplink grant that is allocated to the UE for reporting an interference prediction.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

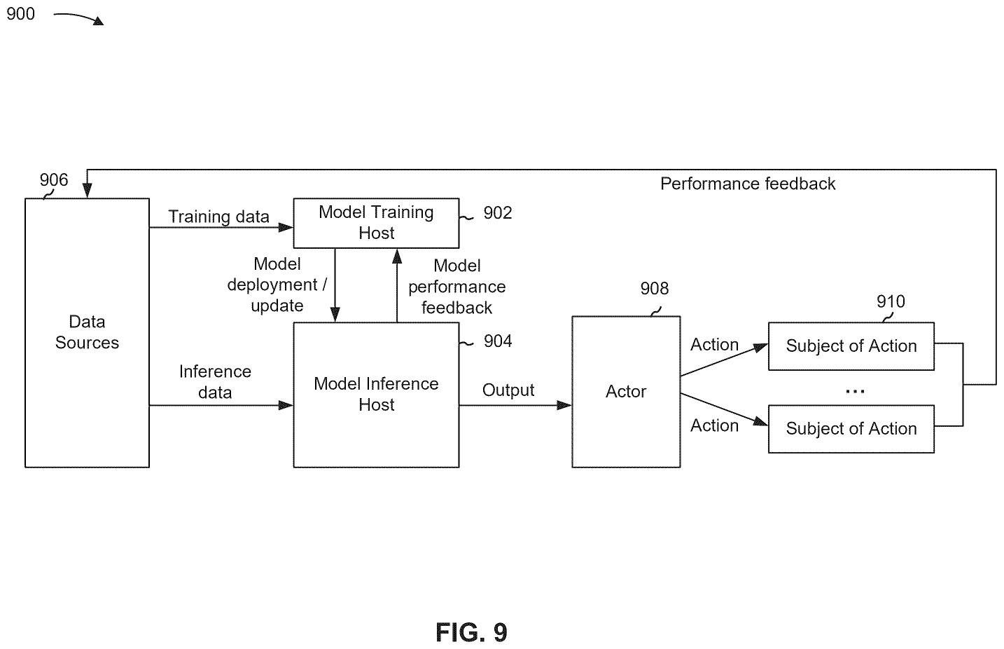

FIG. 9 is a diagram illustrating an example architecture 900 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 900, a functional framework for RAN intelligence may include multiple logical entities, such as a model training host 902, a model inference host 904, data sources 906, and an actor 908.

The model inference host 904 may be configured to run an AI/ML model based on inference data provided by the data sources 906, and the model inference host 904 may produce an output (e.g., a prediction) with the inference data input to the actor 908. The actor 908 may be an element or an entity of a core network or a RAN. For example, the actor 908 may be a UE, a network node, base station (e.g., a gNB), a CU, a DU, and/or an RU, among other examples. In addition, the actor 908 may also depend on the type of tasks performed by the model inference host 904, type of inference data provided to the model inference host 904, and/or type of output produced by the model inference host 904. For example, if the output from the model inference host 904 is associated with position determination, the actor 908 may be a UE, a DU or an RU. In some examples, the model inference host 904 may be hosted on the actor 908. For example, a UE may be the actor 908 and may host the model inference host 904. In some aspects, a UE (e.g., the actor 908) may be a data source 906. For example, the UE may perform a measurement (e.g., an NR measurement), may input the measurement to the AI/ML model at the model inference host 904 (or may provide the measurement to the model inference host 904), and may act based on an output of the AI/ML model (e.g., an interference prediction model).

After the actor 908 receives an output from the model inference host 904, the actor 908 may determine whether to act based on the output. For example, if the actor 908 is a UE and the output from the model inference host 904 is associated with position information, the actor 908 may determine whether to report the position information, reconfigure a beam, among other examples. If the actor 908 determines to act based on the output, in some examples, the actor 908 may indicate the action to at least one subject of action 910.

The data sources 906 may also be configured for collecting data that is used as training data for training an ML model or as inference data for feeding an ML model inference operation. For example, the data sources 906 may collect data from one or more core network and/or RAN entities, which may include the actor 908 or the subject of action 910, and provide the collected data to the model training host 902 for ML model training. In some aspects, the model training host 902 may be co-located with the model inference host 904 and/or the actor 908. For example, the actor 908 or the subject of action 910 may provide performance feedback associated with the beam configuration to the data sources 906, where the performance feedback may be used by the model training host 902 for monitoring or evaluating the ML model performance, such as whether the output (e.g., prediction) provided to the actor 908 is accurate. In some examples, the model training host 902 may monitor or evaluate ML model performance using a training position value, which may be provided by a node (e.g., a UE 120 or a network node 110), as described elsewhere herein. In some examples, if the output provided by the actor 908 is inaccurate (or the accuracy is below an accuracy threshold), then the model training host 902 may determine to modify or retrain the ML model used by the model inference host, such as via an ML model deployment/update.

As indicated above, FIG. 9 is provided as an example. Other examples may differ from what is described with regard to FIG. 9.

The following provides an overview of some Aspects of the present disclosure:

Aspect 1: A method of wireless communication performed by a user equipment (UE), comprising: detecting that an interference prediction event that indicates to generate an interference prediction for a future air interface resource has occurred; and transmitting, based at least in part on detecting that the interference prediction event has occurred, an event-triggered interference prediction report that includes the interference prediction.

Aspect 2: The method of Aspect 1, wherein the interference prediction event comprises at least one of: a measurement metric satisfying a first trigger threshold, a first interference metric generated using a non-serving beam of the UE being lower than a second interference metric generated using a serving beam of the UE, a first signal-to-interference-plus-noise ratio (SINR) metric generated using the non-serving beam of the UE being higher than a second SINR metric generated using the serving beam of the UE, or an interference variation between at least two air interface resources satisfying a second trigger threshold.

Aspect 3: The method of any of Aspects 1-2, further comprising: receiving, prior to detecting the interference prediction event, information that configures the UE to monitor for the interference prediction event.

Aspect 4: The method of any of Aspects 1-3, wherein the interference prediction event is specified by a communication standard.

Aspect 5: The method of any of Aspects 1-4, further comprising: generating the interference prediction using a machine learning model that is trained to predict interference.

Aspect 6: The method of any of Aspects 1-5, wherein the interference prediction event is based at least in part on a statistical computation that uses multiple measurement metrics.

Aspect 7: The method of any of Aspects 1-6, further comprising: updating, based at least in part on detecting that the interference prediction event has occurred, a machine learning model using an interference prediction configuration, the machine learning model being trained to predict interference.

Aspect 8: The method of Aspect 7, wherein the interference prediction configuration comprises at least one of: an interference prediction time window, an interference prediction sampling rate, an interference prediction resource resolution, an interference prediction beam configuration, an interference prediction pattern configuration, an interference prediction bandwidth resolution, a number of sub-band interference predictions, a prediction metric type, an interference autocorrelation matrix prediction resolution, or an interference prediction algorithm type.

Aspect 9: The method of Aspect 8, wherein the interference prediction beam configuration indicates one or more parameters to use for generating the interference prediction, the one or more parameters comprising at least one of: a number of beams, a beam identifier, or a spatial sampling rate.

Aspect 10: The method of Aspect 8 or Aspect 9, wherein the interference prediction pattern configuration comprises at least one of: a temporal interference prediction pattern, or a temporal-spatial interference prediction pattern.

Aspect 11: The method of any one of Aspects 8-10, wherein the interference autocorrelation matrix prediction resolution comprises: a trace resolution of an interference autocorrelation matrix, a diagonal resolution of the interference autocorrelation matrix, or a full matrix resolution of the interference autocorrelation matrix.

Aspect 12: The method of any one of Aspects 8-11, wherein the interference prediction algorithm type comprises: a machine learning model algorithm, or a statistical computation algorithm.

Aspect 13: The method of any one of Aspects 8-12, wherein the prediction metric type comprises at least one of: an interference power prediction metric type, or a signal-to-interference-plus-noise ratio prediction metric type.

Aspect 14: The method of any of Aspects 1-13, further comprising: transmitting an event-detected indication that indicates the detecting of the interference prediction event; and receiving a dynamic uplink grant that is configured for the event-triggered interference prediction report, wherein transmitting the event-triggered interference prediction report comprises: transmitting the event-triggered interference prediction report using the dynamic uplink grant, and wherein transmitting the event-triggered interference prediction report comprises: transmitting the event-triggered interference prediction report using the dynamic uplink grant.

Aspect 15: The method of any of Aspects 1-14, further comprising: receiving a static uplink grant that is allocated to reporting an interference prediction, wherein transmitting the event-triggered interference prediction report comprises: transmitting the event-triggered interference prediction report using the static uplink grant, wherein transmitting the event-triggered interference prediction report comprises: transmitting the event-triggered interference prediction report using the static uplink grant.

Aspect 16: A method of wireless communication performed by a network node, comprising: receiving an event-triggered interference prediction report that includes an interference prediction generated by a user equipment (UE), the event-triggered interference prediction report being associated with an interference prediction event; and transmitting an air interface resource allocation that is assigned to the UE, the air interface resource allocation being configured to mitigate interference that is indicated by the interference prediction.

Aspect 17: The method of Aspect 16, wherein the interference prediction event comprises at least one of: a measurement metric satisfying a first trigger threshold, a first interference metric generated using a non-serving beam of the UE being lower than a second interference metric generated using a serving beam of the UE, a first signal-to-interference-plus-noise ratio (SINR) metric generated using the non-serving beam of the UE being higher than a second SINR metric generated using the serving beam of the UE, or an interference variation between at least two air interface resources satisfying a second trigger threshold.

Aspect 18: The method of any of Aspects 16-17, wherein the interference prediction event is specified by a communication standard.

Aspect 19: The method of any of Aspects 16-18, wherein the interference prediction event is based at least in part on a statistical computation that uses multiple measurement metrics.

Aspect 20: The method of any of Aspects 16-19, further comprising: transmitting information that configures the UE to monitor for the interference prediction event.

Aspect 21: The method of Aspect 20, wherein the information further configures the UE to update, based at least in part on detecting that the interference prediction event has occurred, a machine learning model using an interference prediction configuration, the machine learning model being trained to predict interference.

Aspect 22: The method of Aspect 21, wherein the interference prediction configuration comprises at least one of: an interference prediction time window, an interference prediction sampling rate, an interference prediction resource resolution, an interference prediction beam configuration, an interference prediction pattern configuration, an interference prediction bandwidth resolution, a number of sub-band interference predictions, a prediction metric type, an interference autocorrelation matrix prediction resolution, or an interference prediction algorithm type.

Aspect 23: The method of Aspect 22, wherein the interference prediction beam configuration indicates one or more parameters to use for generating the interference prediction, the one or more parameters comprising at least one of: a number of beams, a beam identifier, or a spatial sampling rate.

Aspect 24: The method of Aspect 22 or Aspect 23, wherein the interference prediction pattern configuration comprises at least one of: a temporal interference prediction pattern, or a temporal-spatial interference prediction pattern.

Aspect 25: The method of any one of Aspects 22-24, wherein the interference autocorrelation matrix prediction resolution comprises: a trace resolution of an interference autocorrelation matrix, a diagonal resolution of the interference autocorrelation matrix, or a full matrix resolution of the interference autocorrelation matrix.

Aspect 26: The method of any one of Aspects 22-25, wherein the interference prediction algorithm type comprises: a machine learning model algorithm, or a statistical computation algorithm.

Aspect 27: The method of any one of Aspects 22-26, wherein the prediction metric type comprises at least one of: an interference power prediction metric type, or a signal-to-interference-plus-noise ratio prediction metric type.

Aspect 28: The method of any of Aspects 16-27, further comprising: receiving an event-detected indication that indicates the interference prediction event has been detected; and transmitting a dynamic uplink grant that is assigned to the UE and is configured for the event-triggered interference prediction report, wherein receiving the event-triggered interference prediction report comprises: receiving the event-triggered interference prediction report using the dynamic uplink grant, wherein receiving the event-triggered interference prediction report comprises: receiving the event-triggered interference prediction report using the dynamic uplink grant.

Aspect 29: The method of any of Aspects 16-28, further comprising: transmitting a static uplink grant that is allocated to the UE for reporting an interference prediction, wherein receiving the event-triggered interference prediction report comprises: receiving the event-triggered interference prediction report using the static uplink grant, wherein receiving the event-triggered interference prediction report comprises: receiving the event-triggered interference prediction report using the static uplink grant.

Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 31: An apparatus for wireless communication at a device, the apparatus comprising one or more memories and one or more processors coupled to the one or more memories, the one or more processors configured to cause the device to perform the method of one or more of Aspects 1-15.

Aspect 32: An apparatus for wireless communication, the apparatus comprising at least one means for performing the method of one or more of Aspects 1-15.

Aspect 33: A non-transitory computer-readable medium storing code for wireless communication, the code comprising instructions executable by one or more processors to perform the method of one or more of Aspects 1-15.

Aspect 34: A non-transitory computer-readable medium storing a set of instructions for wireless communication, the set of instructions comprising one or more instructions that, when executed by one or more processors of a device, cause the device to perform the method of one or more of Aspects 1-15.

Aspect 35: A device for wireless communication, the device comprising a processing system that includes one or more processors and one or more memories coupled with the one or more processors, the processing system configured to cause the device to perform the method of one or more of Aspects 1-15.

Aspect 36: An apparatus for wireless communication at a device, the apparatus comprising one or more memories and one or more processors coupled to the one or more memories, the one or more processors individually or collectively configured to cause the device to perform the method of one or more of Aspects 1-15.

Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 16-29.

Aspect 38: An apparatus for wireless communication at a device, the apparatus comprising one or more memories and one or more processors coupled to the one or more memories, the one or more processors configured to cause the device to perform the method of one or more of Aspects 16-29.

Aspect 39: An apparatus for wireless communication, the apparatus comprising at least one means for performing the method of one or more of Aspects 16-29.

Aspect 40: A non-transitory computer-readable medium storing code for wireless communication, the code comprising instructions executable by one or more processors to perform the method of one or more of Aspects 16-29.

Aspect 41: A non-transitory computer-readable medium storing a set of instructions for wireless communication, the set of instructions comprising one or more instructions that, when executed by one or more processors of a device, cause the device to perform the method of one or more of Aspects 16-29.

Aspect 42: A device for wireless communication, the device comprising a processing system that includes one or more processors and one or more memories coupled with the one or more processors, the processing system configured to cause the device to perform the method of one or more of Aspects 16-29.

Aspect 43: An apparatus for wireless communication at a device, the apparatus comprising one or more memories and one or more processors coupled to the one or more memories, the one or more processors individually or collectively configured to cause the device to perform the method of one or more of Aspects 16-29.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
detect that an interference prediction event that indicates to generate an interference prediction for a future air interface resource has occurred; and
transmit, based at least in part on detecting that the interference prediction event has occurred, an event-triggered interference prediction report that includes the interference prediction.

2. The apparatus of claim 1, wherein the interference prediction event comprises at least one of:
a measurement metric satisfying a first trigger threshold,
a first interference metric generated using a non-serving beam of the UE being lower than a second interference metric generated using a serving beam of the UE,
a first signal-to-interference-plus-noise ratio (SINR) metric generated using the non-serving beam of the UE being higher than a second SINR metric generated using the serving beam of the UE, or
an interference variation between at least two air interface resources satisfying a second trigger threshold.

3. The apparatus of claim 1, wherein the one or more processors are further configured to cause the UE to:
receive, prior to detecting the interference prediction event, information that configures the UE to monitor for the interference prediction event.

4. The apparatus of claim 1, wherein the interference prediction event is based at least in part on a statistical computation that uses multiple measurement metrics.

5. The apparatus of claim 1, wherein the one or more processors are further configured to cause the UE to:
update, based at least in part on detecting that the interference prediction event has occurred, a machine learning model using an interference prediction configuration, the machine learning model being trained to predict interference.

6. The apparatus of claim 5, wherein the interference prediction configuration comprises at least one of:
an interference prediction time window,
an interference prediction sampling rate,
an interference prediction resource resolution,
an interference prediction beam configuration,
an interference prediction pattern configuration,
an interference prediction bandwidth resolution,
a number of sub-band interference predictions,
a prediction metric type,
an interference autocorrelation matrix prediction resolution, or
an interference prediction algorithm type.

7. The apparatus of claim 1, wherein the one or more processors are further configured to cause the UE to:
transmit an event-detected indication that indicates the detecting of the interference prediction event; and
receive a dynamic uplink grant that is configured for the event-triggered interference prediction report,
wherein the one or more processors, to cause the UE to transmit the event-triggered interference prediction report, are configured to cause the UE to:
transmit the event-triggered interference prediction report using the dynamic uplink grant.

8. The apparatus of claim 1, wherein the one or more processors are further configured to cause the UE to:
receive a static uplink grant that is allocated to reporting an interference prediction,
wherein the one or more processors, to cause the UE to transmit the event-triggered interference prediction report, are configured to cause the UE to:
transmit the event-triggered interference prediction report using the static uplink grant.

9. An apparatus for wireless communication at a network node, comprising:
one or more memories; and
one or more processors, coupled to the one or more memories, configured to cause the network node to:
receive an event-triggered interference prediction report that includes an interference prediction generated by a user equipment (UE), the event-triggered interference prediction report being associated with an interference prediction event; and
transmit an air interface resource allocation that is assigned to the UE, the air interface resource allocation being configured to mitigate interference that is indicated by the interference prediction.

10. The apparatus of claim 9, wherein the interference prediction event comprises at least one of:
a measurement metric satisfying a first trigger threshold,
a first interference metric generated using a non-serving beam of the UE being lower than a second interference metric generated using a serving beam of the UE,
a first signal-to-interference-plus-noise ratio (SINR) metric generated using the non-serving beam of the UE being higher than a second SINR metric generated using the serving beam of the UE, or
an interference variation between at least two air interface resources satisfying a second trigger threshold.

11. The apparatus of claim 9, wherein the interference prediction event is based at least in part on a statistical computation that uses multiple measurement metrics.

12. The apparatus of claim 9, wherein the one or more processors are further configured to cause the network node to:
transmit information that configures the UE to monitor for the interference prediction event.

13. The apparatus of claim 12, wherein the information further configures the UE to update, based at least in part on detecting that the interference prediction event has occurred, a machine learning model using an interference prediction configuration, the machine learning model being trained to predict interference.

14. The apparatus of claim 13, wherein the interference prediction configuration comprises at least one of:
an interference prediction time window,
an interference prediction sampling rate,
an interference prediction resource resolution,
an interference prediction beam configuration,
an interference prediction pattern configuration,
an interference prediction bandwidth resolution,
a number of sub-band interference predictions,
a prediction metric type,
an interference autocorrelation matrix prediction resolution, or
an interference prediction algorithm type.

15. The apparatus of claim 9, wherein the one or more processors are further configured to cause the network node to:
receive an event-detected indication that indicates the interference prediction event has been detected; and
transmit a dynamic uplink grant that is assigned to the UE and is configured for the event-triggered interference prediction report,
wherein the one or more processors, to cause the network node to receive the event-triggered interference prediction report, are configured to cause the network node to:
receive the event-triggered interference prediction report using the dynamic uplink grant.

16. The apparatus of claim 9, wherein the one or more processors are further configured to cause the network node to:
transmit a static uplink grant that is allocated to the UE for reporting an interference prediction,
wherein the one or more processors, to cause the network node to receive the event-triggered interference prediction report, are configured to cause the network node to:
receive the event-triggered interference prediction report using the static uplink grant.

17. A method of wireless communication performed by a user equipment (UE), comprising:
detecting that an interference prediction event that indicates to generate an interference prediction for a future air interface resource has occurred; and
transmitting, based at least in part on detecting that the interference prediction event has occurred, an event-triggered interference prediction report that includes the interference prediction.

18. The method of claim 17, wherein the interference prediction event comprises at least one of:
a measurement metric satisfying a first trigger threshold,
a first interference metric generated using a non-serving beam of the UE being lower than a second interference metric generated using a serving beam of the UE,
a first signal-to-interference-plus-noise ratio (SINR) metric generated using the non-serving beam of the UE being higher than a second SINR metric generated using the serving beam of the UE, or
an interference variation between at least two air interface resources satisfying a second trigger threshold.

19. The method of claim 17, further comprising:
receiving, prior to detecting the interference prediction event, information that configures the UE to monitor for the interference prediction event.

20. The method of claim 17, wherein the interference prediction event is based at least in part on a statistical computation that uses multiple measurement metrics.

21. The method of claim 17, further comprising:
updating, based at least in part on detecting that the interference prediction event has occurred, a machine learning model using an interference prediction configuration, the machine learning model being trained to predict interference.

22. The method of claim 21, wherein the interference prediction configuration comprises at least one of:
an interference prediction time window,
an interference prediction sampling rate,
an interference prediction resource resolution,
an interference prediction beam configuration,
an interference prediction pattern configuration,
an interference prediction bandwidth resolution,
a number of sub-band interference predictions,
a prediction metric type,
an interference autocorrelation matrix prediction resolution, or
an interference prediction algorithm type.

23. The method of claim 17, further comprising:
transmitting an event-detected indication that indicates the detecting of the interference prediction event; and
receiving a dynamic uplink grant that is configured for the event-triggered interference prediction report,
wherein transmitting the event-triggered interference prediction report comprises:
transmitting the event-triggered interference prediction report using the dynamic uplink grant.

24. The method of claim 17, further comprising:
receiving a static uplink grant that is allocated to reporting an interference prediction,
wherein transmitting the event-triggered interference prediction report comprises:
transmitting the event-triggered interference prediction report using the static uplink grant.

25. A method of wireless communication performed by a network node, comprising:
receiving an event-triggered interference prediction report that includes an interference prediction generated by a user equipment (UE), the event-triggered interference prediction report being associated with an interference prediction event; and
transmitting an air interface resource allocation that is assigned to the UE, the air interface resource allocation being configured to mitigate interference that is indicated by the interference prediction.

26. The method of claim 25, wherein the interference prediction event comprises at least one of:
a measurement metric satisfying a first trigger threshold,
a first interference metric generated using a non-serving beam of the UE being lower than a second interference metric generated using a serving beam of the UE,
a first signal-to-interference-plus-noise ratio (SINR) metric generated using the non-serving beam of the UE being higher than a second SINR metric generated using the serving beam of the UE, or
an interference variation between at least two air interface resources satisfying a second trigger threshold.

27. The method of claim 25, further comprising:
transmitting information that configures the UE to monitor for the interference prediction event.

28. The method of claim 27, wherein the information further configures the UE to update, based at least in part on detecting that the interference prediction event has occurred, a machine learning model using an interference prediction configuration, the machine learning model being trained to predict interference.

29. The method of claim 28, wherein the interference prediction configuration comprises at least one of:
an interference prediction time window,
an interference prediction sampling rate,
an interference prediction resource resolution,
an interference prediction beam configuration,
an interference prediction pattern configuration,
an interference prediction bandwidth resolution,
a number of sub-band interference predictions,
a prediction metric type,
an interference autocorrelation matrix prediction resolution, or
an interference prediction algorithm type.

30. The method of claim 25, further comprising:
receiving an event-detected indication that indicates the interference prediction event has been detected; and
transmitting a dynamic uplink grant that is assigned to the UE and is configured for the event-triggered interference prediction report,
wherein receiving the event-triggered interference prediction report comprises:
receiving the event-triggered interference prediction report using the dynamic uplink grant.
